(19) United States
(12) Patent Application Publication
(10) Pub. No.: US 2002/0046200 A1
(43) Pub. Date: Apr. 18, 2002

(54) System and method for individually adapted training

(75) Inventors: Mikael Floven, Stockholm (SE); Johan Lidman, Stockholm (SE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: USE YOUR CELL AB, Stockholm (SE)

(21) Appl. No.: 09/881,709

(22) Filed: Jun. 18, 2001

Related U.S. Application Data
(60) Provisional application No. 60/212,363, filed on Jun. 19, 2000.

(30) Foreign Application Priority Data
Jun. 19, 2000 (SE) 0002315-0
Feb. 19, 2001 (SE) 0100564-4

(51) Int. Cl. G06N 5/04

(52) U.S. Cl. 706/61

(57) ABSTRACT

A system for individually adapted interactive training, knowledge maintenance and for offering knowledge support, said system including an apparatus (1) comprising means representing a software-based service, said apparatus being arranged in a communications network (2), to which network a user can connect by means of a user terminal (3) in order to utilise said service. A subject database (4), adapted for storage of data relating to said service, can be connected to said apparatus. Said apparatus comprises a processing means (5) functioning to process and convey data from the subject database to the user, whereby a registration means (6) is provided, functioning to register transactions performed by the user within said service, and to store transaction data in a knowledge database (7) comprised in the apparatus. Said processing means is, according to the invention, arranged to adapt said service to said user in dependence of transactions stored in said knowledge database.

### FIELD OF THE INVENTION

The present invention relates to a system and a method for individually adapted personal intellectual training, knowledge maintenance and for offering knowledge support, and more precisely a system and a method, allowing user access to the system independently of time and geographical location of the user. The invention further relates to a system allowing the user to select, each time he/she uses it, between different user interfaces and terminals.

### BACKGROUND

The development of knowledge in today's society is ever faster, entailing large and ever-increasing needs for acquiring and maintaining knowledge. Knowledge frequently becomes outdated or is forgotten. There are furthermore large differences in competence level, work pace, level of ambition and needs between different individuals.

The amount of available information increases rapidly with modern database technology and connection to local and global networks, for example the Internet. A remaining problem is, however, that in many cases you still have to search for the information, and in order to find what you are seeking, certain knowledge is required. Collection of information and links into catalogues, search engines and portals, are various ways of sorting out certain types of information, but this procedure is still adapted for interesting large groups of users without being tailored for specific individuals, and contributes only very marginally to the knowledge acquisition of the individual. Another problem is that in many cases the individual himself is required to possess knowledge and insight. This kind of problem is increasing continuously, as the time for training with the intention of acquiring and maintaining knowledge is getting more and more scarce. At the same time, mobility in our society is also increasing, making it more and more difficult to be restricted to fixed points in time and geographical locations.

Various methods of utilising the Internet for education, self-studies and tests have been disclosed, as have solutions to the related problems. One example is the patent U.S. Pat. No. 5,909,589 to Parker, in which an apparatus and a method for verifying a user of a network-based application is described. The user initially has to define himself to the system, whereby data typical for the user is input, for example name and phone number. While the application is used, the system detects, in parallel, user-specific characteristics such as key depression pattern, mouse movement pattern and similar, said characteristics being stored in a database. During subsequent use of the application, a verifier provided in the system will check the user characteristics and compare them to the characteristics stored in the database, allowing the system to monitor that the correct user is utilising the application. This might for example be used for verifying the user identity during examination tests via a network. The patent does not, however, address the tuition as such.

### OBJECT OF THE INVENTION

It is an object of the present invention is to provide a method and a system for learning a subject, maintaining this knowledge and for offering knowledge support via a communication network, which overcomes the problems of the known art. One aspect of this object is to offer a system for personal training that is arranged to provide efficient, individually adapted, continuous training, and that will provide an always available knowledge support, independently of time and of the geographical location of the user. It is hereby an object to allow also micro-time, i.e. those short time gaps normally occurring also in the life of a busy individual, to be used efficiently.

### SUMMARY OF THE INVENTION

With the purpose of solving the problems discussed above, the present invention relates to a Personal Trainer, based on a system solution wherein the active utilisation, the actual needs and the personal preferences of the user will guide and support the learning and knowledge utilisation of the user. The Personal Trainer is a new complement to traditional learning methods, such as classroom teaching, seminars, conferences, study tours, etc.

The system according to the invention, hereinafter also called the Personal Trainer, is realised in a communications network, to which a user can connect via a suitable user terminal, or via services such as word processing programs, calculation programs or the like that can be run via a user terminal. A subject database belonging to the system is connected to this network, in which database data relating to one or more specific subjects are stored. The users are given the possibility of communicating with the subject database and using the information contained therein by means of an apparatus realised by a system software being executable in units connected to the network, said apparatus being devised to handle one or several different user services. This apparatus further comprises registration means devised to monitor, transparently for the users, all transactions they perform within a service, and for registering information about said transactions in an individual knowledge database. For example, it will be registered when and how many times a function within the service is activated, or if a question about help put by the user, has been put to the system by the user before. Said apparatus further comprises means for adaptation, in dependence of transactions registered in the knowledge database, of services to unique users. In a preferred embodiment, the system is devised to run services for individually adapted training, knowledge maintenance or for offering knowledge support, the apparatus realised by the system software being devised to adapt, in dependence of transactions registered in the knowledge database, the training/tuition to the user according to his/her requirements or wishes.

The invention thus relates to a system for individually adapted, interactive training, wherein an apparatus comprises means representing a software-based service, said apparatus being provided in a communications network. Users may connect to said communications network, at each individual occasion using a suitable user terminal, e.g. a mobile phone, a PC, a pen computer, a TV set, a game terminal or similar, or via services such as word processors, calculation programs etc.

The apparatus preferably comprises a computer program product arranged to be executed as an application layer in the communications network, said computer software product comprising software that can be run on a computer system for the realisation of said service. The computer system could be a server connected to the network, or several servers distributed in the network. A knowledge database is connected to, or comprised in, the apparatus, devised to register and store, individually for each user, transactions performed by said user within said service. Further, said apparatus is arranged to adapt said service to different users in dependence of transactions stored in the knowledge database.

Preferably, said apparatus is devised to send, within a service, questions, answers and examinations regarding a subject related to the service in question, for example a language training service, the apparatus thereby being devised to adapt automatically the degree of difficulty of the training and the periodicity of the sending to each user, dependent on registered results stored in said knowledge database

### BRIEF DESCRIPTION OF THE DRAWINGS

A preferred embodiment of the invention will be described below, with reference to the appended drawings, wherein:

FIG. 1 illustrates the overall system solution for one embodiment of the invention;

FIG. 2 illustrates the system solution for a personal language trainer arrangement according to the invention;

FIG. 3 illustrates the technical structure of one embodiment of the present invention;

FIG. 4 illustrates one aspect of the function of the present invention;

FIG. 5 illustrates the technical structure, in a larger perspective, of one embodiment of the present invention, with a distributed application layer;

FIG. 6 and FIG. 7 illustrate phrase handling according to an embodiment of the present invention.

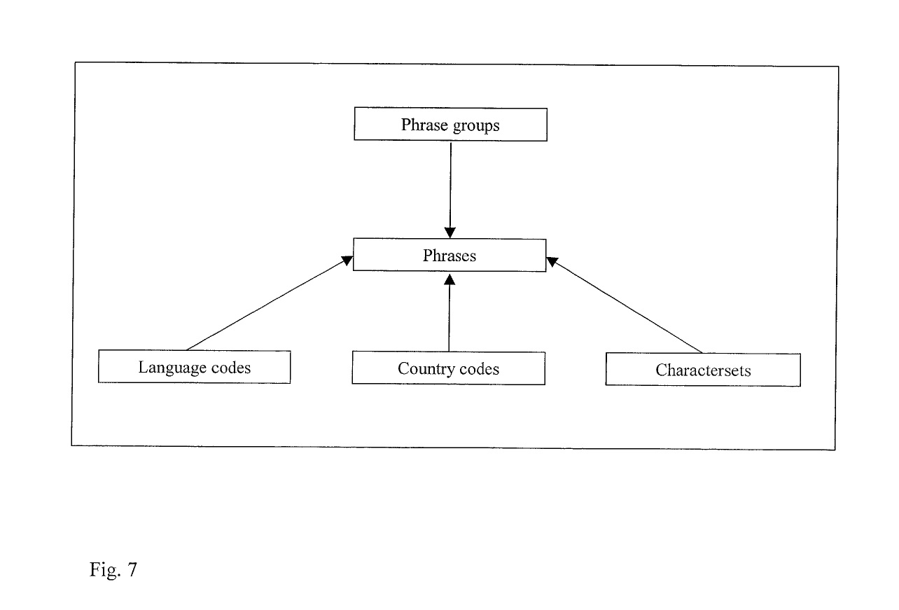

### DETAILED DESCRIPTION OF PREFERRED EMBODIMENTS

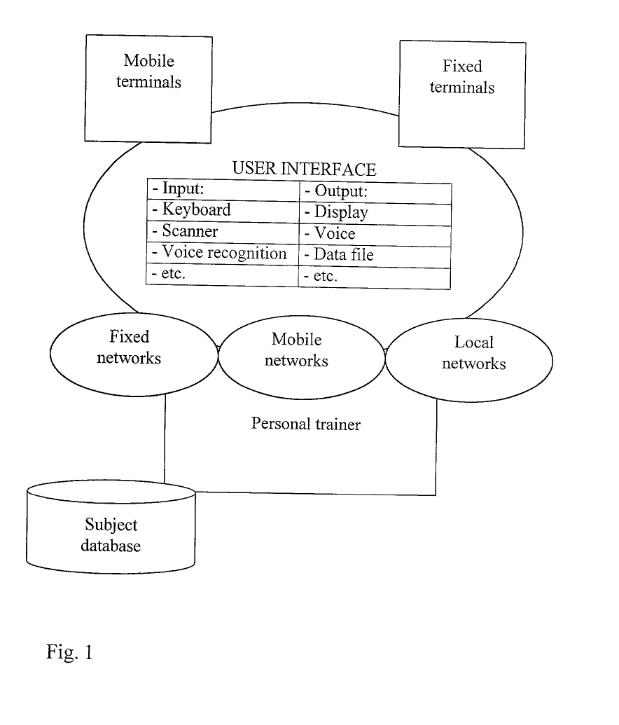

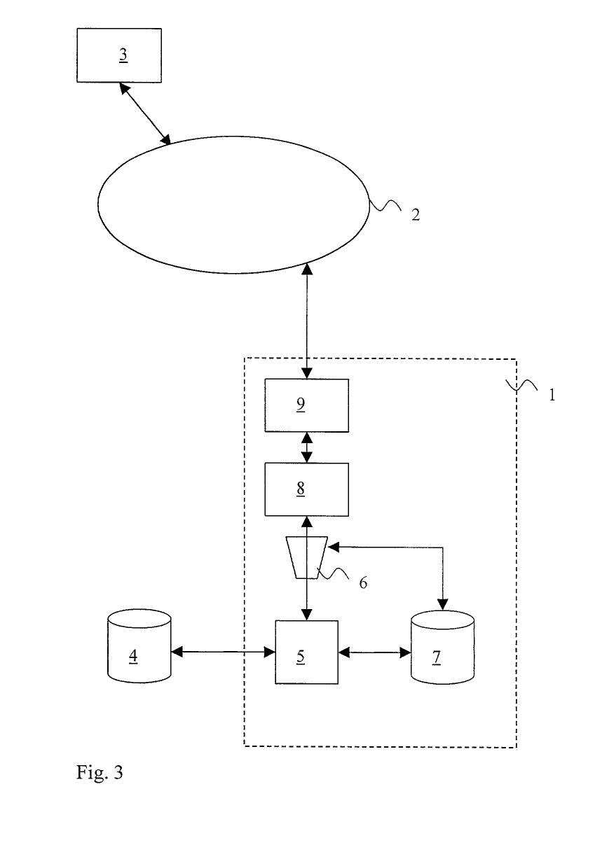

FIG. 1 shows an overall description of the system solution for a Personal Trainer. The Personal Trainer is realised as an interactive software solution in one or several units within a communications network, and the users can be connected to the Personal Trainer by terminals. As indicated by FIG. 1, such terminals can be fixed or mobile, and the user interfaces may vary. The concept of communications network thus includes one or several different networks, and the transmission route for the communication with the software of the Personal Trainer can be selected by each user. With simultaneous reference to FIGS. 1 and 3, it is evident that the software solution for the invention is based upon three basic components:

1. A subject database 4 connected to a communications network 2. The subject database 4 comprises stored information about one or more specific subjects, said information being usable for knowledge training, knowledge maintenance and for offering knowledge support within the subject.

2. System software for using and processing of the information in the subject database 4, for the purpose of realising to the user a service regarding knowledge training, knowledge maintenance and offering knowledge support within the subject.

3. User terminals 3, connectable to the communications network 2 for utilising said services. Said communications network 2 may e.g. be the Internet or any other global network, but may also be an internal and highly limited network.

The system software realises an application layer 1, or an apparatus, and several means comprised in said apparatus 1. The system software realises inter alia a processing means 5, devised to run the actual knowledge service, e.g. to give, in dependence of user questions and information from the subject database, adequate answers or information to the users 3. An identification means 9 is also provided, for identifying the user to the service. The apparatus further comprises software for a personal administrator 8. The personal administrator 8 is a software-realised function that determines and controls on which terms training is to take place, and every user has control of his/her personal administrator 8. The invention is characterised by all the transactions performed by users 3 within a service being registered by a registration means 6 realised by the system software. Information about these transactions is stored individually, for each user of the registration means 6, in a knowledge database 7. Such transaction information may e.g. be whether a certain question has come up before and, if so, when and how often. In order to make the training, the knowledge maintenance, and the knowledge support offered by the service individually adapted, with the intention of rendering the learning more efficient, the processing means 5 is arranged to adapt the services through individual usage of the information registered in the knowledge database 7. The registered information is utilised for training adapted to each individual, e.g.:

Examination, with individually adapted repetition until new knowledge is memorised;

Package solutions, containing, in concentrated form, the information that the user has a need for or exhibits shortcomings within;

Individually adapted games and tasks.

The apparatus 1 thus uses the information in the subject database 4 for building knowledge services, and the information in the knowledge database 7 for individual adaptation of the services to different users.

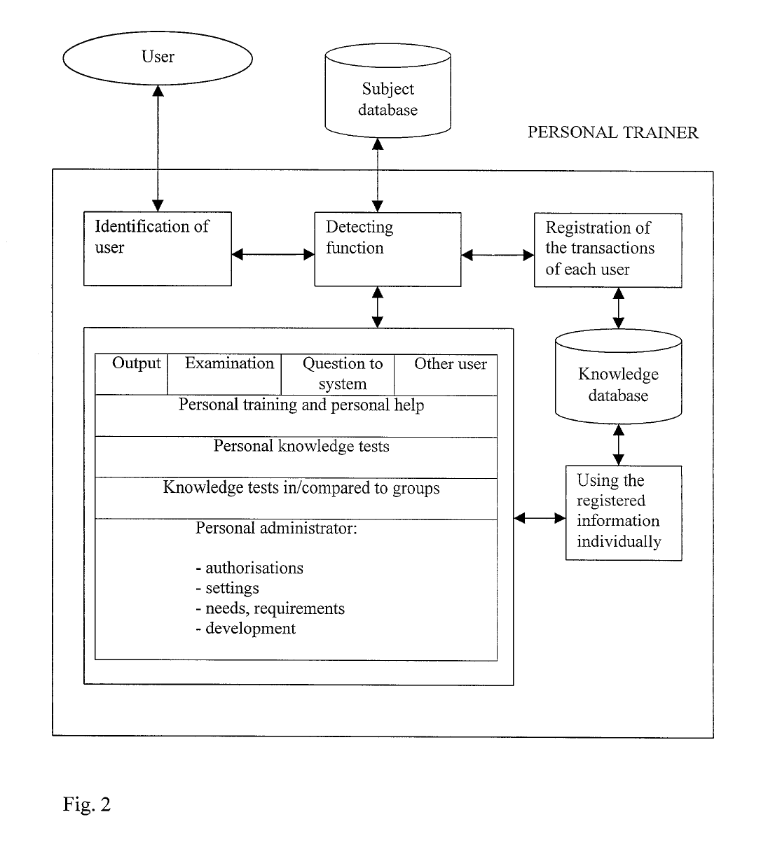

FIG. 2 shows a preferred embodiment of the software solution for a Personal Trainer intended for language training. The users of the system are illustrated in the top portion of the figure, and several bi-directional arrows indicate that the users are able to communicate interactively with the system.

The software solution, which is described in further detail below, is illustrated in the figure as the large central block. The program also has an interface towards the knowledge database, illustrated in the lower portion of the figure. In this knowledge database the transactions of every user are registered and stored, and these transactions are then used by the software, individually for each user, to optimise the Personal Language Trainer.

The main components of the software solution according to the present invention will be described below.

Question to System

The use of this function allows the user to have words translated, and to obtain further information such as synonyms, opposites, etc. Also sentences can be translated, and further information, regarding e.g. grammar, can be given. Further, the system can be fed with data in the form of words, sentences and pronunciation, the system thereby functioning to answer with the pronunciation for said input data, either with a male or a female, synthesised voice. Question to System also includes the function of using a dictionary, encyclopedia or other source of information.

Add to System

With this function, the users may add words, translations and references in dictionaries. The same applies to complete sentences. Such words or sentences may also incorporate slang. Words or sentences added to the system could be private or public, or be presented to or shared with groups or other users, depending on the user's choice.

Output to User

Through the function Output to User, the system can output information to users via their terminals. The following sub-functions are included:

Output of words and sentences with a user-controlled or random periodicity: This service is helpful in order to reduce the user effort requirements when learning a new language. The system will feed the user with words and translations, which the user will later be confronted with during tests where he/she will have to translate him-/herself.

Output of sentences and translations with a user-controlled, predetermined or random periodicity: The object and the advantages of this function are the same as of the preceding one.

Output of tests, including answers, to users.

Output of words and synonyms.

Output of words, synonyms and opposites.

Output of words and sentences, and the corresponding pronunciations from the system, utilising a synthesised voice.

Output of words and sentences, and the corresponding phonemes.

Output of administration data, e.g. data for the user to determine and enter. Such data might for example be personal knowledge level, periodicity and suitable time of day for output. Further adjustable data are type of user terminal and interface, for example mobile phone with communication via voice, SMS or WAP, or an Internet-connected computer, via a browser or a word processing program.

Output of advertising.

The output function is not only intended for training between different languages but also within one language, to improve the language knowledge within the language in question regarding word understanding, spelling, sentence building, sentences, pronunciation, etc.

Examination

Through the Examination service, the system can examine the users. Examination comprises the following functions:

User settings for the Examination service, comprising knowledge level, examination interval, suitable time of day, user terminal and interface, stepping-up of test interval, personal settings regarding statistics, synthesised pronunciation, etc. The system uses the above information to make the Examination service personal and adapted to the knowledge and the habits of the user. It should be noted that the user has a selection of different terminals to make use of during examination by the Personal Trainer, for example cellular communication devices, e-mail, etc.

Users can be examined regarding words, sentences and pronunciation, and regarding dictionary references.

According to the present invention, the system monitors the development by means of the knowledge database provided in the system. This makes it possible for the user to go back and evaluate his/her performance and difficulties.

The system will correct tests and suggest new tests or new, higher or lower, degrees of difficulty in dependence of the result. The system can also be arranged to add words, sentences or pronunciations, from previous tests in which the user has failed, in order to increase the possibilities for the user to exercise individual difficulties. The user can also configure the system to exercise specific words etc. with a shorter interval.

In one embodiment, this function is provided with rewards for success, for example through a lowered annual fee for the service when statistics obtained from the knowledge database show that the user has a low degree of failing in tests, or has a positive results trend.

Users may also make personal tests available to other users or groups.

Question to Friend

This service allows a user to send questions to friends and to send his/her own test results to friends. Furthermore, users can play games with friends based upon the knowledge level via a handicap system.

Language Package

Through this service, the user can obtain access to further dictionaries or wordbooks, either for an entirely new language or for sub-sections within a language, such as economy, technology, etc. The user may also be allowed access to a personally directed or theme-oriented language package, for example if a user plans to visit another country and wishes to exercise words or sentences that might be useful, for example for ordering meals, booking hotel rooms, etc.

Games

Games include the following functions:

Interactive games on the web or in cellular communication systems, with a direct connection to tests in the Personal Trainer. Such games may help in stimulating interactive language training, whilst the user is simultaneously having fun. The user may utilise different terminals when using interactive games, such as personal computers, TV, PDA, mobile phones, etc.

Games available by downloading from the Internet or distributed CD:s, with games and Language Trainer integrated.

Examples of how the Personal Trainer interacts with games, are games using words and sentences and where success is defined trough translation of words or sentences, or when the correct word or sentence is selected from a multi-choice list. Success can furthermore be defined as the knowledge of the correct answer to questions based on dictionary references, or the knowledge of the correct pronunciation, or selection of the correct pronunciation from a multi-choice list, for words or sentences.

Test Service

The Test Service allows the administrative staff at the Service Provider's (SP) to create and maintain tests, and also allows users to create their own tests and to make them public.

Dictionary Service

The Dictionary Service comprises a function for allowing users to buy and use several different dictionaries, and for users to select which dictionaries to use when interacting with the system. There is also a function allowing the SP's administrative staff to add new dictionaries and to make them available to users.

User Service

This concept comprises the functions for user identification, certificate of authenticity, debiting, statistics and personal user settings. These personal user settings may comprise membership status, subscription levels, available dictionaries, examination settings, output settings, etc. This concept also includes the user submitting his permission to store information at an individual level.

The system for the Personal Trainer thus comprises a multitude of different components within the software. The heart of the Personal Trainer is a language dictionary comprising all the world's major languages, plus further underlying dictionaries within each language.

FIG. 3 generally illustrates, by way of a block diagram, the technical system description for the system according to the present invention. The system comprises an apparatus 1, preferably including an application layer realised by a software that can be run on a computer system in a communications network 2, and a knowledge database 7. Said computer system may be arranged in a network unit, or be distributed in the communications network 2. In one embodiment, the application layer is realised in a server connected to the communications network 2 via a web server. The web server is in turn preferably protected from the network 2 by means of a firewall, in a known manner. When said software is executed in said computer system, a service is thus made available in accordance with the present invention. A multitude of users subscribing to the service are further connected to the communications network 2 via user terminals 3. According to the invention, each user can utilise the service with several different types of user terminals 3. Such types of user terminals 3 include computers, mobile phones and PDA:s, but also interfaces arranged within such terminals, such as a browser or a word processing program.

This of course simultaneously implies that the communications network 2 comprises a multitude of different networks, such as a mobile phone network, the Internet and an Intranet, to which said terminals 3 are connected.

The present invention thus relates to a network-based system for individually adapted interactive training, said system including an apparatus 1 comprising means representing a software-based service. The apparatus is arranged in a communications network 2, to which a user can connect by means of a user terminal in order to utilise said service. A first database 4 can be connected to said apparatus, said database being adapted for storage of data relating to said service. The invention is characterised by said apparatus comprising a processing means 5 devised to process and convey data from the first database to the user. This processing means comprises a computer program adapted to process data in dependence of external conditions. The apparatus further comprises a registration means 6, devised to register transactions performed by the user within said service, and to store transaction data in a second database 7 comprised in the apparatus. The registration means is also a computer program, arranged to be run in parallel with the users' communication with the processing means, transparently for the users. Said processing means is arranged to adapt said service to said user in dependence of transactions stored in said second database relating to said user.

Said apparatus further comprises an administration means 8, also called the personal administrator, arranged so that each user can configure said service in accordance with his/her needs. The administration means can be set by the user from any one of his/her user terminals that can be connected to the system. The apparatus preferably also comprises an identification means 9, adapted for identification and authentication of said user to said apparatus. The identification can be made through passwords, voice recognition or other methods.

Said service is preferably a training program for a given subject, for example a language as was described previously, said first database then being a subject database 4 in which information within said subject is stored. According to what has been discussed above, the subject database for languages may include words, pronunciation information, sentence building information, etc. Said second database is a user-specific knowledge database 7 in which data related to the knowledge level of the user is stored.

Said processing means is arranged to perform, within said service, various actions, including sending questions, answers or examinations within said subject to said user, or receiving questions or answers within said subject from said user, in accordance with what has been described earlier. According to the invention, the processing means is arranged to adapt the degree of difficulty of such questions and examinations in dependence of the data registered in said knowledge database for said user. In a preferred embodiment, the knowledge database is built up by said registration means registering all the transactions performed by the user within the service. Such transactions may e.g. be questions or answers to the system, or examination results. For a specific stage within said subject, e.g. spelling, the processing means is arranged to investigate data stored in the knowledge database regarding this stage, and to adapt the action correspondingly. For example, the processing means may provide spelling tasks more often that include the words with which the user in question has difficulties, according to the documentation in the database. In another embodiment, said registration means is arranged to detect errors, e.g. faulty spelling, directly in the answers from the user, and to register information about said errors in the knowledge database, whereby said processing means is arranged to design said training programs in dependence of information stored in the knowledge database.

In one embodiment, said processing means in said training program is arranged to send questions to said user with a periodicity defined by the user in said administration means. The periodicity can also be dependent of information stored in the knowledge database, or be entirely random.

In one embodiment of the invention, data representing a predetermined knowledge level are stored in said knowledge database. As an example, a knowledge package can be ordered that corresponds to a suitable level for the user, e.g. corresponding to a certain grade in compulsory school. Said processing means is hereby arranged to adapt the degree of difficulty of said questions and examinations in dependence of said predetermined knowledge level.

According to the invention, the user can utilise one or a multitude of different user terminals when communicating with the system. Preferably, the user can set the type of user terminal himself, in said administration means, the personal administrator. If the user has defined a number of different types of user terminals, e.g. a mobile phone, an Internet computer and a PDA in the form of a pen computer, the system is able to send data to the user in various ways. If the system initiates transmission without a preceding question from the user, it could for example be performed with so-called push, using an SMS message. If the transmission is preceded and initiated by data received from the user, the system will preferably send data back to the user via the same medium. According to the invention, said service can be activated by the user, via said communications network, at an arbitrary point in time selected by the user, and by means of a user terminal determined by the user. This renders the system an unprecedented flexibility, whilst the individual knowledge database provided in the system simultaneously warrants a personally adapted training.

The method of exercising the invention is characterised by the steps of the user sending first data to said apparatus, information related to said first data being registered in the knowledge database, the apparatus processing second data from the subject database in dependence of said first data from said knowledge database, and the apparatus sending said processed second data back to said user. Said first data might for example represent a statement or an answer to a question put by the apparatus regarding one aspect of said subject, and said second data might represent a question regarding the same aspect of said subject, the apparatus hereby adapting the degree of difficulty of the question in said second data in dependence of said first data. As the knowledge database is a database being built up gradually, it should be recognised that said first data could have been sent long before said second data, and therefore does not have to be initiating for the sending of said second data. On the other hand, for example, a previously sent erroneous answer to a certain question, that has been registered in the knowledge database, could be the reason for that specific question to be brought up again when sending questions to the user.

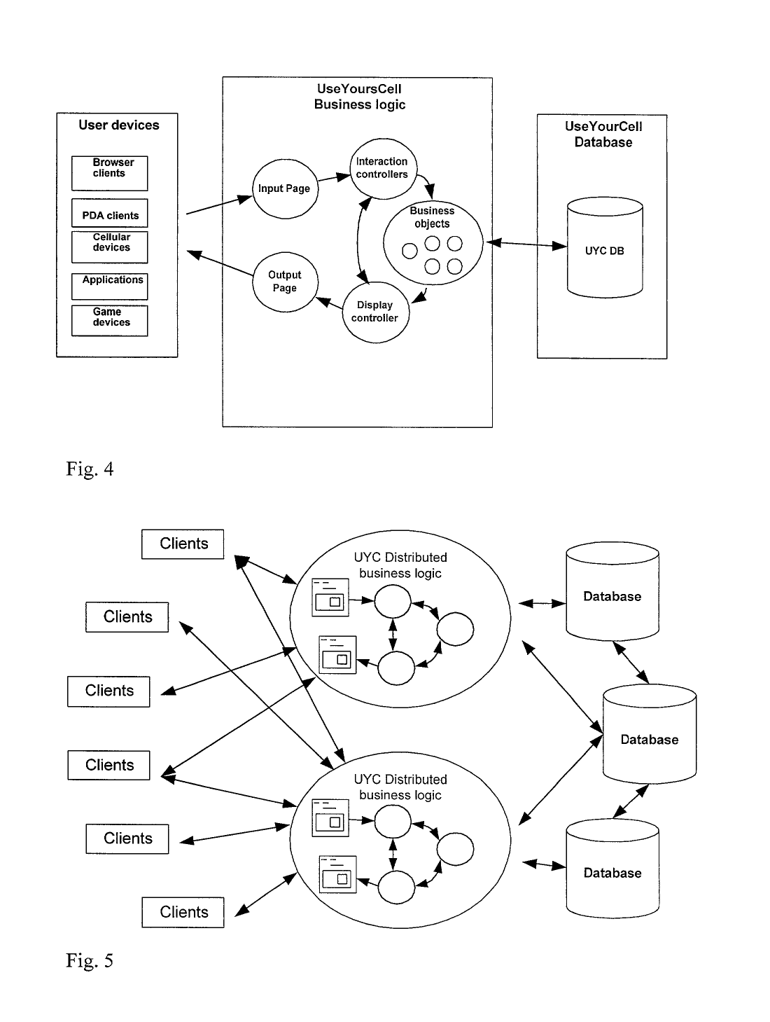

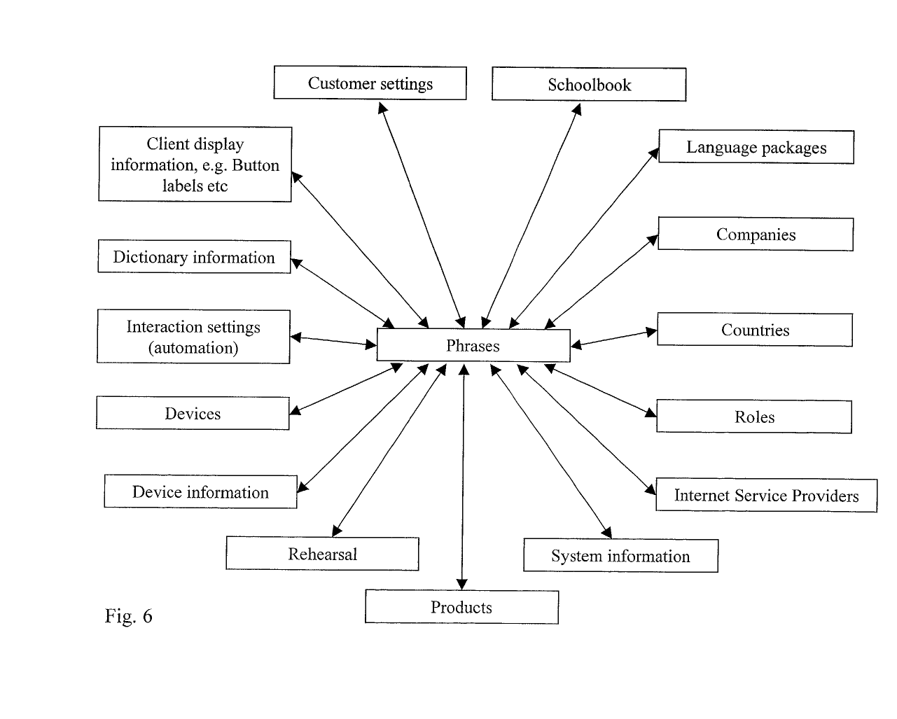

FIG. 4 shows the system according to the present invention, where the overall function of the system software realising the apparatus of the system is indicated by means of arrows and software units, whilst simultaneously illustrating clearly that several different user terminals can be utilised. Further, the subject database is clearly indicated as a separate element in the system. In one embodiment, the system services according to the present invention are distributed multi-layer applications, and in FIG. 5, a distributed solution of the system according to the present invention is shown, in an exemplifying and schematic fashion.

In a preferred embodiment the system comprises a general handling of phrases where all the standard phrases of the system (i.e. phrases which are used for information within the system, and towards clients) can be dynamically changed to another language. This general handling of phrases is concentrated to a module to which all other parts are tied, i.e. the rest of the system is completely integrated with the phrase handling module. All the standard phrases of the system are stored in the phrase module, e.g. business names, role names, profile names, dictionary names, rehearsal descriptions, menus and so on, marked with language code and land code (Locale) and character sets (Latin- 1 etc.). The construction of the phrase module permits storage of any selectable word or phrase in different languages where the system arranges so that the correct phrase is presented in the correct language with the correct character set, and so that the language may by switched dynamically if so desired. The phrase module also permits grouping of phrases, e.g. product names grouped together, business names in another group, etc., where the possibility for the client to make a selectable own grouping. Each unique phrase (word or sentence) may be complemented with a selectable number of variables ({1},{2} etc.), which variables may be switched for a selectable word or sentence from the language data base with coupling to a selectable number of words or sentences in other languages. The phrase module allows registration of phrases in different languages with or without coupling to a translator application. The customer has the capability of administering new phrases in the system as long as these are supported by the system's functionality. Only phrases that are directly registered by the end user are stored outside the phrase module, however with language and character pointers.

The present invention differs from the prior art in that the system keeps track of each user independently. Furthermore, the knowledge status of each user is not determined by how far into a curriculum the user has reached, but rather by the results the user has obtained in tests or rehearsal, the questions raised by the user, the problems or type of problems detected in answers from the user etc. This way the system according to the present invention is arranged to adapt the training within a certain subject personally for each client or user. Apart from training, the system is also arranged to provide knowledge maintenance and to offer knowledge support within any subject for which the system is adapted. By adapting the training of a user to his or her knowledge status, the education is tailored to the needs, demands and learning capabilities of the user. Furthermore, time is saved since no effort is wasted on posing and answering questions or tests within fields in which the user already has a high degree of knowledge.

In one embodiment the present invention is adapted for knowledge training or maintenance within the field of a certain language. The student, i.e. the user, may be provided with a certain text, such as a chapter of or an entire book, for self-reading.

Linked to this text is a glossary comprising all or certain words in the aforementioned text, preferably words which are supposedly previously unknown to the student. The assumed difficulty in understanding certain words may be based upon prior stored knowledge status, or in an initial phase e.g. on age or grade of a curriculum. Said glossary may be used by the system according to the present invention for tests of the student's knowledge and progress in learning. The words from the glossary may be used to form simple word tests, but may also be put into sentences or phrases, in order to check whether the student understands the context in which the word may be found. Such phrases may be fetched from the subject database, which in the case of the subject language may be found under the specific word in a standard dictionary.

Since the system according to the invention is adapted to log and store all transactions made by the student, i.e. which form of tests or rehearsal the student has gone through, the results he or she has obtained and the errors made, both in terms of type and quantity, the system will keep track of the difficulties the specific student has. When the student is subsequently provided with a new text to study, there may be words in that text which are knew also compared to the previous text, and words or sentences which were previously disclosed but which have also been detected as problematic for the student, e.g. in terms of understanding, spelling, translation or inflection. If the text is in a digital format, all the words and phrases of the text is known to the system. Hence, the system is capable of, and comprises means for, matching the knowledge status of the student with the content of this knew text. Dependent on the set-up of the system, new words may be presented to the user in a glossary when they appear in the text, and this glossary can be set-up by the system if it is not already present, since the system is connected to the subject database. The system may also be set-up not to present true meaning or translation of the new words, but rather to let the student study the full text firstly, and thereafter to present the student with questions or tests related to the new words. Furthermore, such tests and rehearsals or questions may also be generated for words which appear once again in the new text, and which has previously been detected as difficult for the student.

All transactions made by the user, there among the results obtained in a test, rehearsal or the like, are saved and stored in the personal knowledge database for the specific user, and are thereafter used to adapt and shape subsequent personal knowledge training or maintenance to the present individual knowledge status. This way the risk for the learning pace to fade, or the actual knowledge status to decline or certain knowledge to be forgotten, is minimized. In dependence of the settings selected by the user, said user may be fed with questions or tests with selectable frequency and specifically adapted in terms of difficulty with respect to the present knowledge status. This way the system will automatically detect progress in learning, and the system may therefore be adapted to automatically increase the difficulty level upon such detection.

For the specific example of language training or knowledge maintenance different type of errors may be detected, such as word recognition, grammar, word inflection etc. Subsequent tests or questions may therefore be focused on the specific type of errors detected. As previously mentioned, different type of terminals or interfaces may be used for communication between the system and the user. In terms of questions or tests, the answers given by the user and detected by the system may be in the form of voice replies, detectable by voice recognition means associated with the system. In another embodiment the responses or answers made by the student may be given and detected in text format. In yet another embodiment the answers to specific questions may be given as multiple choice selections, wherein the selected answer is detected by the system through sensing which alternative answer the student has indicated.

Needless to say, the system according to the present invention may be adapted to any type of subject in which learning and maintenance of knowledge is desired. Examples of such subjects are driving school theory, training and tests for a hunter examination, computer skills etc. The described embodiment relating to language should therefore merely be regarded as an example, devised to illustrate the features and advantages of the invention. It is hence evident to the person skilled in the art that numerous variations are conceivable within the scope of the appended claims.

1. A system for individually adapted interactive training, knowledge maintenance and for offering knowledge support, said system including:
an apparatus comprising means representing a software-based service, said apparatus being arranged in a
communications network, to which a user can connect by means of a
user terminal in order to utilise said service, and to which apparatus a
first database can be connected, said database being arranged for storage of data relating to said service, characterised by said apparatus comprising processing means devised to process and convey data from the first database to the user, registration means, devised to register transactions performed by the user within said service, and to store transaction data in a second database comprised in the apparatus, said processing means being arranged to adapt said service to said user in dependence of transactions stored in said second database relating to said user.

2. The system according to claim 1, wherein said apparatus comprises administration means, adapted for configuring said service to said user, said administration means being adjustable from said user terminal.

3. The system according to claim 2, wherein said apparatus comprises identification means, adapted for identification of said user to said apparatus.

4. The system according to claim 3, wherein said service is a program for training, knowledge maintenance and for offering knowledge support relating to a given subject, said first database being a subject database in which information within said subject is stored, and said second database being a user-specific knowledge database in which data related to the knowledge level of the user is stored.

5. The system according to claim 4, wherein said processing means is arranged to perform, within said service, various actions, including sending questions, answers or examinations within said subject to said user, or receiving questions or answers within said subject from said user, the processing means being arranged to adapt the degree of difficulty of such questions and examinations in dependence of the data registered in said knowledge database for said user.

6. The system according to claim 5, wherein said registration means is arranged for registering all the transactions performed by the user within the service, and wherein, for a specific stage within said subject, the processing means is arranged to investigate data stored in the knowledge database regarding this stage, and to adapt the action correspondingly.

7. The system according to claim 5, wherein said registration means is arranged to detect errors in answers from the user, and to register information about said errors in the knowledge database, whereby said processing means is arranged to design said training program in dependence of information stored in the knowledge database.

8. The system according to claim 6 or 7, wherein said processing means of said training program is arranged to send questions to said user with a periodicity defined by the user in said administration means.

9. The system according to claim 6 or 7, wherein said processing means of said training program is arranged to send questions to said user with a periodicity dependent of information stored in the knowledge database.

10. The system according to claim 6 or 7, wherein said processing means of said training program is arranged to send questions to said user with a random periodicity.

11. The system according to claim 5, wherein data representing a predetermined knowledge level are stored in said knowledge database, and wherein said processing means is arranged to adapt the degree of difficulty of said questions and examinations in dependence of said predetermined knowledge level.

12. The system according to any one of the preceding claims, wherein the type of user terminal can be set by the user in said administration means.

13. The system according to claim 12, wherein said apparatus is arranged for receiving data from several different types of user terminal, defined in said administration means.

14. The system according to claim 12, wherein said apparatus is arranged for transmitting data to a type of user terminal that is defined in said administration means.

15. The system according to claim 13 or 14, wherein said apparatus is arranged for transmitting data, in dependence of data received from a transmitting user terminal, to the transmitting terminal.

16. The system according to claim 12, wherein said type of user terminal is a computer provided with a browser as the interface to the communications network.

17. The system according to claim 12, wherein said type of user terminal is a computer provided with a word processing program as the interface to the communications network.

18. The system according to claim 12, wherein said type of user terminal is a mobile phone.

19. The system according to claim 12, wherein said type of user terminal is a PDA.

20. The system according to claim 12, wherein said type of user terminal is a game console.

21. The system according to any one of the preceding claims, wherein said subject is a language.

22. The system according to any one of the preceding claims, wherein said service allows activation by the user, via said communications network, at a point in time selected by the user.

23. A method for individually adapted interactive training, knowledge maintenance and for offering knowledge support via a communications network, wherein a software-based service is arranged in an apparatus in said communications network, to which communications network a user can connect by means of a user terminal in order to utilise said service, and wherein a first database, for storage of data relating to said service, is connected to the apparatus, characterised by the steps of:
the user sending first data to said apparatus;
information related to said first data being registered in a second database;
the apparatus processing second data from said first database in dependence of said first data from said second database; and
the apparatus sending said processed second data back to said user.

24. The method according to claim 23, wherein said service is a training program concerning a given subject, said first database being a subject database in which information within said subject is stored, and said second database being a user-specific knowledge database in which data relating to the knowledge level of the user is stored.

25. The method according to claim 24, wherein data representing a predetermined knowledge level are stored in said knowledge database.

26. The method according to claim 24 or 25, wherein said first data represent a statement or an answer to a question put by the apparatus regarding an aspect of said subject, and said second data represent a question regarding the same aspect of said subject, the apparatus adapting the degree of difficulty of the question in said second data in dependence of said first data.

27. The method according to claim 26, wherein the apparatus adapts the periodicity for sending the question in said second data in dependence of said first data.

28. The method according to claim 27, wherein the user configures, via said user terminal, the apparatus for individual adaptation of said service.

29. The method according to claim 28, wherein said apparatus registers all transactions performed by the user within the service.

30. The method according to claim 28, wherein said registration means detects errors in answers or statements from the user, and registers information about said errors in the knowledge database.
